(19) United States
(12) Patent Application Publication
(10) Pub. No.: US 2016/0126817 A1
(43) Pub. Date: May 5, 2016

(54) Automobile automatic transmission

(71) Applicant: Jinqing Hu, Qingdao (CN)

(72) Inventor: Jinqing Hu, Qingdao (CN)

(21) Appl. No.: 14/994,145

(22) Filed: Jan. 13, 2016

Related U.S. Application Data
(63) Continuation of application No. PCT/CN2014/080178, filed on Jun. 18, 2014.

(30) Foreign Application Priority Data
Jul. 16, 2013 (CN) 201310308791.X

(51) Int. Cl. H02K 16/00; H02K 11/33; B60L 11/18

(52) U.S. Cl. CPC H02K 16/005; B60L 11/1803; H02K 11/33

(57) ABSTRACT

An automobile automatic transmission with a double-rotor structure, comprising an internal rotor (1), an external rotor (2), a right end cover (3), a left end cover (4), bearings (5) and collecting rings (6), wherein the internal rotor (1) is connected with an output shaft of an engine, and the external rotor (2) is connected to an input shaft of a main speed reducer. The automobile automatic transmission is characterized in that the external rotor (2) is formed by processing entity steel and can bear a large torque; two-phase excitation windings at intervals are evenly arranged on the internal rotor (1); the collecting rings (6) have four lines and are respectively connected to two full bridges of a controller for outputting, and not only can a constant magnetic field be formed on the internal rotor (1) by inputting direct currents, but also a positive and negative rotating magnetic field can be formed by inputting two-phase alternating currents with a phase difference of +/−90 degrees. The problem that the automobile automatic transmissions are high in manufacturing cost and small in speed change range is solved, and the automobile automatic transmission is suitable for various automobiles using gasoline engines and diesel engines as power.

### CROSS-REFERENCE TO RELATED APPLICATIONS

This application is a continuation of International Patent Application No. PCT/CN2014/080178 with an international filing date of Jun. 18, 2014 designating the United States, now pending and further claims priority benefits to Chinese Patent Application No. 201310308791.X filed Jul. 16, 2013. The content of the aforementioned application, including any intervening amendments thereto, is incorporated herein by reference.

### TECHNICAL FIELD

The invention relates to the field of the automobile industry, in particular to an automobile automatic transmission.

### BACKGROUND ART

At present, automobile automatic transmissions all transmit power in a manner of mechanical connection, and mainly in a manner of gear transmission and a manner of pulley transmission.

The automobile automatic transmissions for transmitting power in a manner of mechanical connection have the problems that the automobile automatic transmissions are complex in structure and high in manufacturing cost, and during the speed change in the manner of gear transmission or the manner of pulley transmission, the transformation ratio range of the automobile automatic transmissions is narrow due to the limitation of the mechanical dimensions of speed change wheels.

### SUMMARY OF THE INVENTION

The technical solution of the invention is that an automobile automatic transmission which is of a double-rotor structure and transmits power by means of electromagnetic coupling comprises an internal rotor, an external rotor, a left end cover, a right end cover, bearings and collecting rings, wherein the internal rotor is connected with an output shaft of an engine, and the external rotor is connected to an input shaft of a main speed reducer. The automobile automatic transmission is characterized in that the external rotor is formed by processing entity steel and can bear a large torque; two-phase excitation windings at intervals are evenly arranged on the internal rotor; the collecting rings have four lines and are respectively connected to two full bridges of a controller for outputting, and not only can a constant magnetic field be formed on the internal rotor by inputting direct currents, but also a positive and negative rotating magnetic field can be formed by inputting two-phase alternating currents with a phase difference of +/−90 degrees.

On the conditions of engine starting, after it is determined through the controller that a brake pedal is stepped on or a hand brake is pulled up, alternating currents with a phase difference of +/−90 degrees are input into the two-phase excitation windings, and the transmission becomes a two-phase asynchronous motor since the external rotor is static. An engine crankshaft can be driven by the internal rotor in a manner of frequency conversion and voltage transformation to gradually perform accelerated rotation, and the starting impact on the engine is smaller than that of a universally adopted manner of starting through a direct-current motor. When the engine is in the idling conditions, currents of the excitation windings are zero, and the internal rotor rotates synchronously with the engine. In view of the fact that the internal rotor has a certain rotational inertia, engine flywheels may be reduced or omitted.

On the conditions of automobile starting and acceleration, direct currents are input into the excitation windings to form the constant magnetic field on the internal rotor, and since the internal rotor rotates synchronously with the engine, the rotating magnetic field synchronous with the engine is generated in the transmission. During the acceleration, the rotating speed of the internal rotor is larger than that of the external rotor, and by adjusting the rotating speed difference between the internal rotor and the external rotor and exciting currents, a torque expected by a driver can be generated to drive an automobile to be accelerated. For example, if the rotating speed of the external rotor is 20 r/min in the starting process, the rotating speed of the engine is increased to 2000 r/min so as to improve the starting performance, and the transformation ratio is 100. In fact, the transformation ratio may be infinitely large, and the automobile can be directly started from a static state on the conditions that a clutch is omitted.

On the high-speed and low-load conditions of an automobile, alternating currents with a phase difference of +90 degrees are input into the excitation windings, and the rotating speed of the rotating magnetic field in the transmission is the sum of the rotating speed of the engine and the rotating speed of the rotating magnetic field generated by the alternating currents. For example, if the rotating speed of the engine is 1500 r/min and the rotating speed of the rotating magnetic field generated by the alternating currents is 1000 r/min, on the conditions of taking no account of slip, the rotating speed of the external rotor can reach 2500 r/min, and the transformation ratio is 0.6. The conditions of deceleration braking of an automobile are divided into two situations. One situation is that the direct currents are input into the excitation windings to form the constant magnetic field on the internal rotor, the external rotor is dragged by the engine to be decelerated, and a dragging torque can be changed by adjusting the exciting currents, so as to generate a sliding distance expected by the driver; the other situation is that when the automobile undergoes emergency braking during high-speed running, the alternating currents with a phase difference of −90 degrees are input into the excitation windings, a reverse rotating magnetic field is formed, so that the braking torque is increased, and the emergency braking distance during high-speed running is reduced.

The invention has the technical effects that by adopting the above-mentioned technical solution, an automobile automatic transmission which is simpler in structure, lower in cost and larger in transformation ratio range can be achieved.

### BRIEF DESCRIPTION OF THE ACCOMPANYING DRAWINGS

FIG. 1 is a structural front view of the invention and serves as an accompanying drawing for the abstract;

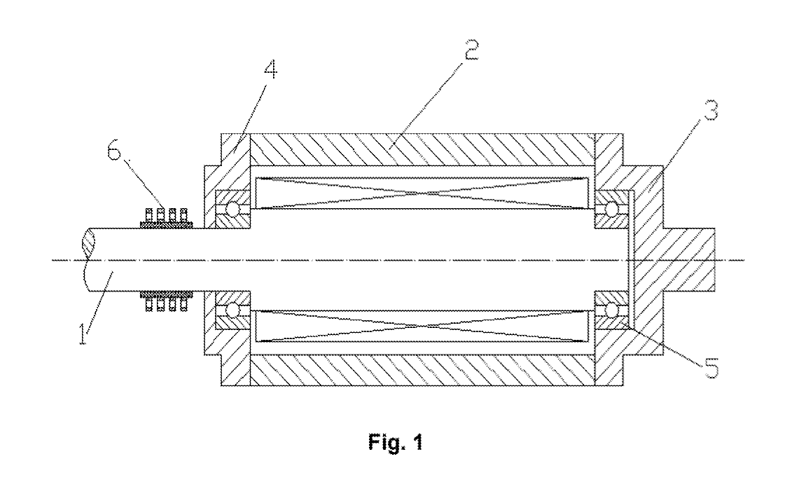

FIG. 2 is a structural drawing of two-phase excitation windings of an internal rotor;

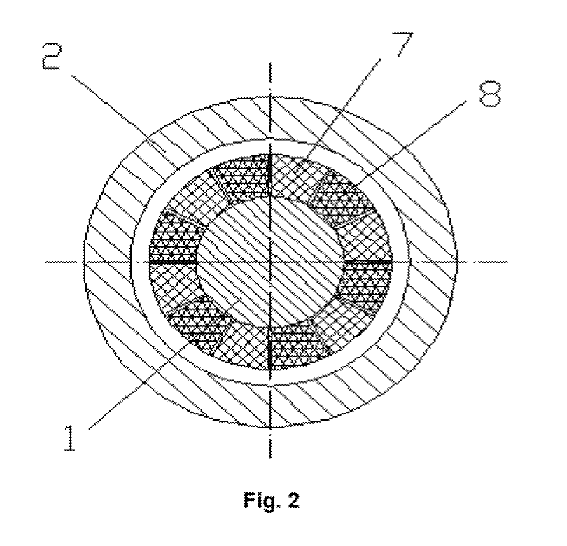

FIG. 3 is a connecting circuit diagram of excitation windings and a controller.

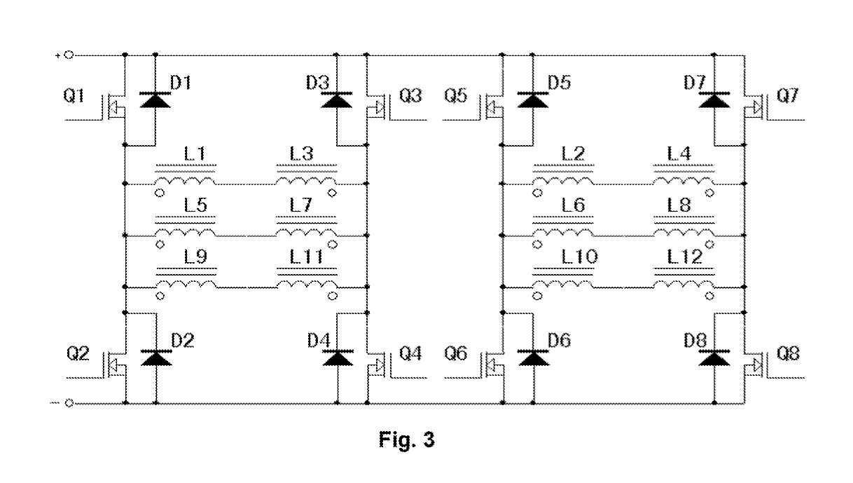

In the drawings, there is an internal rotor (1), an external rotor (2), a right end cover (3), a left end cover (4), bearings (5), collecting rings (6), phase-A excitation windings (7) and phase-B excitation windings (8).

### EMBODIMENTS OF THE INVENTION

The invention is further described below in combination with drawings and embodiments.

As shown in the drawings, an internal rotor (1) and an external rotor (2) are connected and supported by means of a right end cover (3), a left end cover (4) and bearings (5) and can rotate freely axially. The internal rotor (1) is connected with an output shaft of an engine, and the external rotor (2) is connected to an input shaft of a main speed reducer The external rotor (2) is formed by processing entity steel and can bear a large torque. In this embodiment, 12 phase-A excitation windings (7) and phase-B excitation windings (8) at intervals are evenly arranged on the internal rotor (1). The phase-A excitation windings (7) are formed by windings (L1, L3, L5, L7, L9 and L11), and the phase-B excitation windings (8) are formed by windings (L2, L4, L6, L8, L10 and L12). Collecting rings (6) have four lines, and the excitation windings are respectively connected to the output ends of phase-A full bridges (Q1, Q2, Q3 and Q4) and phase-B full bridges (Q5, Q6, Q7 and Q8) of a controller A. Not only can a constant magnetic field be formed on the internal rotor by inputting direct currents into the excitation windings, but also a positive and negative rotating magnetic field can be formed by inputting two-phase alternating currents with a phase difference of +/−90 degrees into the excitation windings.

On the conditions of automobile starting and acceleration, switching tubes (Q1, Q4, Q5 and Q8) are connected and switching tubes (Q2, Q3, Q6 and Q7) are disconnected; direct currents in the excitation windings generate a magnetic field invariable in direction, the polarity of the magnetic field formed on the surface of the internal rotor is as shown in Table 1, and obviously the magnetic field is a three-pole-pair magnetic field. Due to the fact that the internal rotor rotates synchronously with the engine, a rotating magnetic field is generated, and the rotating magnetic field drives the external rotor to rotate. The switching tubes (Q4 and Q8) change the intensity of the magnetic field by controlling currents in a manner of pulse width modulation, so as to adjust an acceleration torque. When the automobile engine is subjected to dragging deceleration, the connecting and disconnection states of the switching tubes are similar, and the magnetic field direction is also as shown in Table 1.

TABLE 1
Polar distribution of a magnetic field generated by direct currents

| | Winding number | | | | | | | | | | | |
|---|---|---|---|---|---|---|---|---|---|---|---|---|
| | L1 | L2 | L3 | L4 | L5 | L6 | L7 | L8 | L9 | L10 | L11 | L12 |
| Magnetic | N | N | S | S | N | N | S | S | N | N | S | S |
| field | | | | | | | | | | | | |
| polarity | | | | | | | | | | | | |

On the high-speed and low-load conditions of an automobile, phase-A full bridges (Q1, Q2, Q3 and Q4) and phase-B full bridges (Q5, Q6, Q7 and Q8) generate square wave alternating currents with a phase difference of +90 degrees. The polarity changes of the magnetic field generated by the square wave alternating currents are as shown in Table 2, and it is not difficult to see that the magnetic field is a three-pole-pair magnetic field which rotates clockwise. The rotating speed of the rotating magnetic field in the transmission is the sum of the rotating speed of the engine and the rotating speed of the rotating magnetic field generated by the alternating currents. For example, if the frequency of the alternating currents is 50 Hz and the rotating speed of the rotating magnetic field generated by three-pole-pair excitation windings is 1000 r/min, supposing that the rotating speed of the engine is 1500 r/min, the rotating speed of the rotating magnetic field in the transmission is 2500 r/min.

TABLE 2
A rotating magnetic field generated by alternating currents with a
phase difference of +90 degrees

| Electrical | Winding number | | | | | | | | | | | |
|---|---|---|---|---|---|---|---|---|---|---|---|---|
| angle | L1 | L2 | L3 | L4 | L5 | L6 | L7 | L8 | L9 | L10 | L11 | L12 |
| 0 degree | N | N | S | S | N | N | S | S | N | N | S | S |
| 90 degree | S | N | N | S | S | N | N | S | S | N | N | S |
| 180 degree | S | S | N | N | S | S | N | N | S | S | N | N |
| 270 degree | N | S | S | N | N | S | S | N | N | S | S | N |
| 360 degree | N | N | S | S | N | N | S | S | N | N | S | S |

When the automobile undergoes emergency braking during high-speed running, phase-A full bridges (Q1, Q2, Q3 and Q4) and phase-B full bridges (Q5, Q6, Q7 and Q8) generate square wave alternating currents with a phase difference of −90 degrees. The polarity changes of the magnetic field generated by square wave alternating currents are as shown in Table 3, and the magnetic field is a three-pole-pair magnetic field which rotates anticlockwise. The rotating direction of the magnetic field is opposite to the rotating direction of the external rotor, and accordingly a reverse braking torque is generated. If the engine is started through the transmission, the phase-A full bridges (Q1, Q2, Q3 and Q4) and the phase-B full bridges (Q5, Q6, Q7 and Q8) generate square wave alternating currents with a phase difference of −90 degrees. The polarity changes of the magnetic field generated by the square wave alternating currents are also as shown in Table 2, and only the frequency is gradually increased from 0 Hz to 50 Hz.

TABLE 3
A rotating magnetic field generated by alternating currents
with a phase difference of −90 degrees

| Electrical | Winding number | | | | | | | | | | | |
|---|---|---|---|---|---|---|---|---|---|---|---|---|
| angle | L1 | L2 | L3 | L4 | L5 | L6 | L7 | L8 | L9 | L10 | L11 | L12 |
| 0 degree | N | N | S | S | N | N | S | S | N | N | S | S |
| 90 degree | N | S | S | N | N | S | S | N | N | S | S | N |
| 180 degree | S | S | N | N | S | S | N | N | S | S | N | N |
| 270 degree | S | N | N | S | S | N | N | S | S | N | N | S |
| 360 degree | N | N | S | S | N | N | S | S | N | N | S | S |

1. An automobile automatic transmission with a double-rotor structure, comprising an internal rotor, an external rotor, a left end cover, a right end cover, bearings and collecting rings, wherein the internal rotor and the external rotor are connected and supported by means of the left end cover, the right end cover and the bearings and can rotate freely axially; the external rotor is formed by processing entity steel and can bear a large torque; two-phase excitation windings at intervals are evenly arranged on the internal rotor; the collecting rings have four lines and are respectively connected to two full bridges of a controller for outputting, and not only can a constant magnetic field be formed on the internal rotor by inputting direct currents, but also a positive and negative rotating magnetic field can be formed by inputting two-phase alternating currents with a phase difference of +/−90 degrees.
